(19) United States
(12) Patent Application Publication
(10) Pub. No.: US 2026/0129658 A1
(43) Pub. Date: May 7, 2026

(54) METHOD AND APPARATUS FOR SCHEDULING MULTIPLE PSSCHS BY A SINGLE SCI

(71) Applicant: Lenovo (Beijing) Limited, Beijing (CN)

(72) Inventors: Haipeng Lei, Beijing (CN); Xin Guo, Beijing (CN); Xiaodong Yu, Beijing (CN); Zhennian Sun, Beijing (CN)

(73) Assignee: Lenovo (Beijing) Limited, Beijing (CN)

(21) Appl. No.: 18/994,360

(22) PCT Filed: Jul. 15, 2022
(86) PCT No.: PCT/CN2022/105915

§ 371 Date: Jan. 14, 2025

(51) Int. Cl. H04W 72/25; H04L 5/00

(52) U.S. Cl. CPC H04W 72/25; H04L 5/0055

(57) ABSTRACT

Embodiments of the present disclosure relate to methods and apparatuses for multiple PSSCHs scheduling by a single SCI. According to some embodiments of the disclosure, a UE may: receive a plurality of PSSCHs scheduled by a first SCI, wherein the plurality of PSSCHs carry at least one TB; determine, based on an indicator in the first SCI, a number of the at least one TB; generate HARQ-ACK information bits for the plurality of PSSCHs, wherein a number of the HARQ-ACK information bits is based on the number of the at least one TB; and transmit the HARQ-ACK information bits.

### TECHNICAL FIELD

Embodiments of the present disclosure generally relate to wireless communication technology, and more particularly to scheduling a plurality of physical sidelink shared channels (PSSCHs) by single sidelink control information (SCI).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmissions may be performed on a licensed spectrum and an unlicensed spectrum.

There is a need for handling sidelink transmissions on an unlicensed spectrum.

### SUMMARY

Some embodiments of the present disclosure provide a first user equipment (UE). The first UE may include a transceiver, and a processor coupled to the transceiver. The processor may be configured to: receive a plurality of physical sidelink shared channels (PSSCHs) scheduled by first sidelink control information (SCI), wherein the plurality of PSSCHs carry at least one transport block (TB); determine, based on an indicator in the first SCI, a number of the at least one TB; generate hybrid automatic repeat request acknowledgement (HARQ-ACK) information bits for the plurality of PSSCHs, wherein a number of the HARQ-ACK information bits is based on the number of the at least one TB; and transmit the HARQ-ACK information bits.

In some embodiments of the present disclosure, the indicator may indicate whether a single TB is repeated on the plurality of PSSCHs or each of the plurality of PSSCHs carries a different TB. In some examples, the indicator is specific for multi-PSSCH scheduling. In some examples, an SCI format indicator in the first SCI is reused as the indicator.

Some embodiments of the present disclosure provide a second user equipment (UE). The second UE may include a transceiver, and a processor coupled to the transceiver. The processor may be configured to: transmit first sidelink control information (SCI) and a plurality of physical sidelink shared channels (PSSCHs), wherein the plurality of PSSCHs is scheduled by the first SCI for carrying at least one transport block (TB) and the first SCI includes an indicator indicating a number of the at least one TB; and receive hybrid automatic repeat request acknowledgement (HARQ-ACK) information bits for the plurality of PSSCHs, wherein a number of the HARQ-ACK information bits is based on the number of the at least one TB.

In some embodiments of the present disclosure, the indicator may indicate the number of the at least one TB being X.

In some embodiments of the present disclosure, each of the at least one TB may be mapped to an approximately equal number of PSSCHs of the plurality of PSSCHs. In some embodiments, each of a number of the at least one TB may be mapped to a first number of PSSCHs of the plurality of PSSCHs and each of the remaining TBs of the at least one TB may be mapped to a second number of PSSCHs of the plurality of PSSCHs. The difference between the first number and the second number may be equal to 0 or 1.

In some embodiments of the present disclosure, the processor may be further configured to transmit a TB repetition number. The at least one TB may be mapped to the plurality of PSSCHs based on the TB repetition number. In some embodiments, each of a first number of TBs of the at least one TB may be transmitted on a number of PSSCHs equal to the TB repetition number among the plurality of PSSCHs, and each of the remaining TBs of the at least one TB may be transmitted on a number of PSSCHs smaller than the TB repetition number among the plurality of PSSCHs.

In some embodiments of the present disclosure, the at least one TB may be one-to-one mapped to the first X PSSCHs of the plurality of PSSCHs and then repeatedly one-to-one mapped to the remaining PSSCHs of the plurality of PSSCHs until there are no remaining PSSCHs in the plurality of PSSCHs.

In some embodiments of the present disclosure, the indicator may indicate whether a single TB is repeated on the plurality of PSSCHs or each of the plurality of PSSCHs carries a different TB. In some embodiments, the indicator may be specific for multi-PSSCH scheduling. In some embodiments, an SCI format indicator in the first SCI may be reused as the indicator.

In some embodiments of the present disclosure, a first TB of the at least one TB may be mapped to a first set of PSSCHs of the plurality of PSSCHs, the first SCI may indicate a first redundancy version (RV) for a first scheduled PSSCH of the first set of PSSCHs, and an RV(s) for the remaining PSSCH(s) of the first set of PSSCHs follows the first RV based on an RV pattern. In some embodiments, the RV pattern may be configured by RRC signaling, or predefined, or preconfigured for the second UE. In some embodiments, the RV pattern may be indicated by the first SCI from a set of RV patterns, which may be configured by RRC signaling, or predefined, or preconfigured for the second UE.

In some embodiments of the present disclosure, a first TB of the at least one TB may be mapped to a first set of PSSCHs of the plurality of PSSCHs, the first SCI may indicate an RV pattern for the first set of PSSCHs, and an RV(s) for the PSSCH(s) of the first set of PSSCHs follows the RV pattern in order.

In some embodiments of the present disclosure, the first SCI may further schedule a second SCI. In some embodiments, the second SCI may be multiplexed on a first scheduled PSSCH of the plurality of PSSCHs. In some embodiments, the second SCI may be multiplexed on each of the plurality of PSSCHs, or a set of PSSCHs of the plurality of PSSCHs.

In some embodiments of the present disclosure, the first SCI may include the indicator, and a payload size of the second SCI may be determined based on: the number of the at least one TB, a maximum number of TBs schedulable by the first SCI, or the indicator and the maximum number of TBs schedulable by the first SCI.

In some embodiments of the present disclosure, the second SCI may include the indicator, and a payload size of the second SCI may be determined based on the maximum number of TBs schedulable by the first SCI or the second SCI.

Some embodiments of the present disclosure provide a method for wireless communication performed by a first UE. The method may include: receiving a plurality of physical sidelink shared channels (PSSCHs) scheduled by first sidelink control information (SCI), wherein the plurality of PSSCHs carry at least one transport block (TB): determining, based on an indicator in the first SCI, a number of the at least one TB: generating hybrid automatic repeat request acknowledgement (HARQ-ACK) information bits for the plurality of PSSCHs, wherein a number of the HARQ-ACK information bits is based on the number of the at least one TB; and transmitting the HARQ-ACK information bits.

Some embodiments of the present disclosure provide a method for wireless communication performed by a second UE. The method may include: transmitting first sidelink control information (SCI) and a plurality of physical sidelink shared channels (PSSCHs), wherein the plurality of PSSCHs is scheduled by the first SCI for carrying at least one transport block (TB) and the first SCI includes an indicator indicating a number of the at least one TB; and receiving hybrid automatic repeat request acknowledgement (HARQ-ACK) information bits for the plurality of PSSCHs, wherein a number of the HARQ-ACK information bits is based on the number of the at least one TB.

Some embodiments of the present disclosure provide an apparatus. According to some embodiments of the present disclosure, the apparatus may include: at least one non-transitory computer-readable medium having stored thereon computer-executable instructions: at least one receiving circuitry: at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an exemplary UE-initiated COT structure in accordance with some embodiments of the present disclosure:

FIG. 3 illustrates an exemplary multiple PSSCHs scheduling in accordance with some embodiments of the present disclosure:

FIGS. 4 and 5 illustrate a flow chart of an exemplary procedure of sidelink communication in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1). In some embodiments, UE 110a, UE 110b, and UE 110c may form a UE group.

Sidelink transmissions may involve a physical sidelink control channel (PSCCH) and an associated physical sidelink shared channel (PSSCH), which are scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

The PSSCH may carry data which may require corresponding HARQ-ACK feedback from the Rx UE(s) to the Tx UE. The HARQ-ACK feedback for a PSSCH may be carried on a physical sidelink feedback channel (PSFCH).

In some embodiments of the present disclosure, sidelink transmissions may be performed on an unlicensed spectrum. This is advantageous because a sidelink transmission over an unlicensed spectrum can achieve, for example, an increased data rate(s). In order to achieve fair coexistence between various systems, for example, NR systems (e.g., NR-U systems) and other wireless systems, a channel access procedure, also known as a listen-before-talk (LBT) test, may be performed before communicating on the unlicensed spectrum.

Various types of channel access procedures including, but not limited to, channel access Type 1 and channel access Type 2 may be supported. In some embodiments, by performing channel access Type 1 (also known as LBT Cat.4), a UE can initiate a channel occupancy (CO) and occupy the channel until the maximum channel occupancy time (MCOT). In some embodiments, the MCOT can be 2 ms, 3 ms, 4 ms, 6 ms, 8 ms or 10 ms, dependent on, for example, a channel access priority class (CAPC) value of the traffic priority and the presence of other technologies sharing the same spectrum.

To avoid the risk of losing the channel, similar to a DL burst and UL burst, a sidelink burst can be defined as a set of transmissions from a UE without any gaps greater than 16 us. One or more consecutive slots can be included in a sidelink burst. In some embodiments, each PSCCH or PSSCH may start from symbol 0 of a specific slot to avoid complicated designs at both the Tx UE side and Rx UE side.

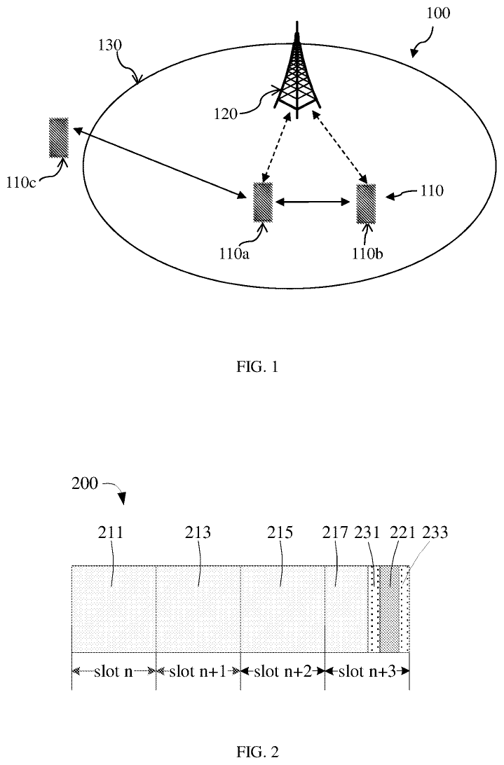

FIG. 2 shows an exemplary UE-initiated COT 200 structure in accordance with some embodiments of the present disclosure.

In some embodiments, a UE may initiate UE-initiated COT 200 by performing a channel access procedure (e.g., channel access Type 1) using, for example, a CAPC value 2. The UE then can contiguously transmit 4 PSCCHs or PSSCHs in four consecutive slots (e.g., slot n to slot n+3 as shown in FIG. 2) without sensing. For example, for each of slot n to slot n+3, the UE may transmit a SCI in the corresponding slot to schedule a PSSCH (e.g., one of PSSCHs 211-217) in the corresponding slot. Time domain resource 221 may correspond to a PSFCH transmission occasion, and gap 231 and gap 233 may be arranged before and after time domain resource 221. Assuming that gap 231 starts at symbol 10, then in the example of FIG. 2, the sidelink burst can include slot n to slot n+3 from symbol 0 of slot n to symbol 9 of slot n+3.

It should be understood that the COT structure in FIG. 2 is only for illustrative purposes, and should not be construed as limiting the embodiments of the present disclosure. For example, in some other embodiments of the present disclosure, a COT structure may not include a time domain resource for PSFCH transmission.

In some embodiments of the present disclosure, multi-slot or multi-PSSCH scheduling may be supported on a sidelink. Using a single SCI to schedule a plurality of slots or a plurality of PSSCHs would be advantageous because it can greatly reduce the signaling overhead. Embodiments of the present disclosure provide solutions to improve the multi-slot or multi-PSSCH scheduling when it is applied to sidelink transmissions over, for example, an unlicensed spectrum.

For example, in some embodiments, a sidelink transmission may support up to 3 resources reserved within 32 slots for one TB. A UE should know whether the plurality of PSSCHs scheduled by a single SCI carries the same TB or different TBs. Embodiments of the present disclosure provide solutions to inform the UE of such information.

For example, in some embodiments, one PSFCH may correspond to one PSSCH. In these embodiments, for the plurality of scheduled PSSCHs, multiple PSFCHs may be needed in the same slot. In the case of the same TB repetition on the plurality of scheduled PSSCHs, a single bit of HARQ-ACK feedback for the TB may be sufficient. The PSFCH resource is wasted if multiple PSFCHs are transmitted for the plurality of PSSCHs carrying the same TB. Embodiments of the present disclosure provide solutions to avoid such resource waste. For example, a solution which can indicate an Rx UE to only transmit a single bit for the plurality of scheduled PSSCHs in the case of TB repetition is provided.

For example, in some embodiments, when the same TB repetition is carried by more than one scheduled PSSCH, different redundancy versions (RVs) can achieve a better performance. Embodiments of the present disclosure provide solutions to apply different RVs for the same TB repetition and inform a UE of the RV pattern for the TB repetition.

More details on the embodiments of the present disclosure will be illustrated in the following text in combination with the appended drawings.

In some embodiments of the present disclosure, a single SCI may schedule a plurality of PSSCHs in one or more slots. The plurality of PSSCHs may carry at least one TB. The SCI may indicate the number of the at least one TB. HARQ-ACK information bits for the plurality of PSSCHs can be generated based on the indication in the SCI. It should be noted that in the context of the present disclosure, a slot may include more than one PSSCH (e.g., two PSSCHs). If standards don't allow more than one PSSCH in a slot, then the number of slots is equivalent to the number of PSSCHs. The SCI may indicate the number of scheduled slots, or the number of scheduled PSSCHs, and RRC signaling may configure the maximum number of slots which can be scheduled by one SCI.

For example, in some embodiments of the present disclosure, an indicator (denoted as indicator #1) in a SCI (denoted as SCI #1) may indicate the number of TBs (denoted as X) carried by the plurality of PSSCHs (e.g., Y PSSCHs) scheduled by SCI #1.

In some embodiments, the number of bits required for indicator #1 may be dependent on the maximum number of TBs (or PSSCHs) which can be scheduled by a single SCI (denoted as M). For example, assuming a maximum of M TBs (or PSSCHs) can be scheduled by a single SCI, [log₂ M] bits may be required to indicate the number of actually scheduled TBs. The value of M may be configured by radio resource control (RRC) signaling or predefined in, for example, a standard(s).

In some embodiments, the number of PSSCHs (e.g., Y) scheduled by a SCI can be determined according to various manners. For example, Y can be directly indicated, for example, by the SCI or RRC signaling, or implicitly derived based on start and length indicator values (SLIVs) in a time domain resource allocation (TDRA) table.

In some examples, when a TB can be transmitted only on one PSSCH (i.e., without TB repetition), then the number of actually scheduled TBs is equal to the number of scheduled PSSCHs (e.g., X=Y). When a TB can be transmitted on more than one PSSCHs by means of TB repetition, then the number of TBs indicated by indicator #1 may be smaller than the number of scheduled PSSCHs (e.g., X<Y). Various methods may be employed to map the scheduled TBs on the scheduled PSSCHs when the number of scheduled TBs is smaller than the number of scheduled PSSCHs.

For example, in some embodiments of the present disclosure, each of the at least one TB may be mapped to an approximately equal number of PSSCHs of the plurality of PSSCHs.

For example, each of a number of the at least one TB (e.g., z TBs) may be mapped to a number of PSSCHs (denoted as y₁) of the plurality of PSSCHs and each of the remaining TBs of the at least one TB (e.g., X-z TBs) may be mapped to another number of PSSCHs (denoted as y₂) of the plurality of PSSCHs. In some examples, the difference between y₁ and y₂ may be equal to 0 or 1. For example, the value of z, y₁ and y₂ can be determined based on the below equations. According to the below equations, within the X scheduled TBs, each of the first z TBs may be transmitted on y₁ PSSCHs, and each of the remaining X-z TBs may be transmitted on y₂ PSSCHs.

$$z = mod ( Y , X ) ,$$

$${y}_{1} = ⌈ \frac{Y}{X} ⌉ , and$$

$${y}_{2} = ⌊ \frac{Y}{X} ⌋ .$$

For example, assuming that Y=8 and X=3, then z=2, y₁=3, and y₂=2. Therefore, each of the first two TBs occupies 3 PSSCHs and the last TB occupies the remaining 2 PSSCHs.

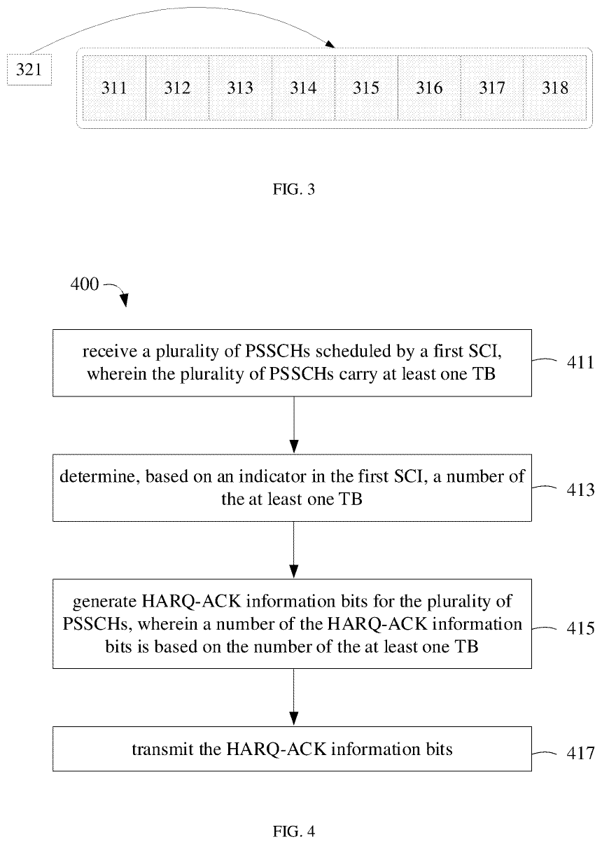

For example, referring to FIG. 3, SCI 321 may schedule a plurality of PSSCHs (e.g., PSSCHs 311-318). Assuming that three TBs (denoted as TB #1, TB #2 and TB #3) are scheduled to be transmitted on PSSCHs 311-318, then each of PSSCHs 311-313 may carry TB #1, each of PSSCHs 314-316 may carry TB #2, and each of PSSCHs 317 and 318 may carry TB #3.

In some embodiments of the present disclosure, the at least one TB may be mapped to the plurality of PSSCHs based on a TB repetition number (denoted as K). The TB repetition number may be configured by RRC signaling, indicated by the SCI, predefined in, for example, a standard(s), or determined according to various manners.

In some embodiments, each of a number of TBs of the at least one TB may be transmitted on K PSSCHs among the plurality of scheduled PSSCHs, and each of the remaining TBs of the at least one TB may be transmitted on a number of PSSCHs smaller than K among the plurality of PSSCHs. For example, each of (X-1) TBs (e.g., the first (X-1) TBs) of the X TBs may have K transmissions on K PSSCHs and the remaining one TB (e.g., the last TB) may have Y−(X-1)×K transmissions on Y-(X-1)×K PSSCHs. In some examples, the values of X, K and Y may satisfy (X-1)×K<Y<=X×K.

For example, it is assumed that 3 TBs are scheduled on 8 PSSCHs via a single SCI and each TB is configured to have 3 transmissions (i.e., X=3, Y=8, and K=3, which satisfies (X-1)×K<Y<=XxK). Therefore, each of the first two TBs can have 3 transmissions and the last TB can have 2 transmissions. For example, referring again to FIG. 3, TB #1 may be repeated on PSSCHs 311-313, TB #2 may be repeated on PSSCHs 314-316, and TB #3 may be repeated on PSSCHs 317 and 318.

In some embodiments of the present disclosure, the at least one TB may be one-to-one mapped to the first X PSSCHs of the plurality of PSSCHs and then repeatedly one-to-one mapped to the remaining PSSCHs of the plurality of PSSCHs until there are no remaining PSSCHs in the plurality of PSSCHs. The last several TBs of the X TBs may have fewer transmissions than other TBs of the X TBs.

For example, referring to FIG. 3, TB #1, TB #2 and TB #3 may be firstly mapped to PSSCHs 311-313 respectively, and then may be respectively mapped to PSSCHs 314-316, and TB #1 and TB #2 may be respectively mapped to PSSCHs 317 and 318.

When the same TB repetition is carried on a set of PSSCHs of the plurality of scheduled PSSCHs (for example, referring to FIG. 3, each of PSSCHs 311-313 may carry the same TB (e.g., TB #1) in some cases), an ordering of the RVs (also referred to as an RV pattern) for the same TB repetition on the set of PSSCHs may need to be defined.

In some embodiments of the present disclosure, the SCI may include an RV indicator to indicate a single RV (denoted as RV #1). RV #1 may correspond to a specific PSSCH (e.g., the first scheduled PSSCH) of the set of PSSCHs which carry the same TB. The RV(s) for the remaining PSSCH(s) of the set of PSSCHs may follow RV #1 based on an RV pattern. In some examples, the RV pattern may be configured by RRC signaling, predefined, or preconfigured for the UE. In some examples, the RV pattern may be indicated by the SCI from a set of RV patterns. The set of RV patterns may be configured by RRC signaling, predefined, or preconfigured for the UE. In this way, a UE may know the RV pattern used for the scheduled PSSCHs.

In some examples, possible RV patterns can include {0/2/3/1}, {0/3/0/3}, or {0/0/0/0}. In some examples, possible RV patterns can include {0/2/3}, {0/2}, {0/3}, or {0/0}. In some cases, the number of RVs within an RV pattern may be larger than the number of PSSCHs for a TB, especially when the TB has fewer transmissions than the other TBs scheduled by the same SCI. In such cases, one or more RVs within the determined RV pattern may not be used for the set of PSSCHs carrying the TB. In some cases, the number of RVs within an RV pattern may be smaller than the number of PSSCHs for a TB, and the RV pattern may be repeatedly applied to the number of PSSCHs carrying the same TB. For example, assuming that RV pattern {0/2/3} is used and there are five PSSCHs carrying the same TB, the RVs for the five PSSCHs may be RV0, RV2, RV3, RV0, and RV2.

For example, in some embodiments, the RV pattern may be configured by RRC signaling, for example, from a set of possible RV patterns, for a UE. The UE may transmit a SCI scheduling a plurality of PSSCHs carrying at least one TB. In some examples, each of the at least one TB may be transmitted on one or more PSSCHs of the plurality of PSSCHs. Assuming that TB #A1 is repeatedly transmitted on PSSCH #1, PSSCH #2 and PSSCH #3 of the plurality of PSSCHs, and the configured RV pattern is {0/2/3/1}, the SCI may indicate a single RV (e.g., RV0) which correspond PSSCH #1. Then, RVs for PSSCH #2 and PSSCH #3 may be RV2 and RV3, respectively, according to the configured RV pattern.

For example, referring again to FIG. 3, it is assumed that TB #1 is repeatedly transmitted on PSSCHs 311-313, TB #2 is repeatedly transmitted on PSSCHs 314-316, and TB #3 is repeatedly transmitted on PSSCHs 317 and 318 and the configured RV pattern is {0/2/3/1}. Assuming that SCI 321 indicates RV0, then according to the RV pattern, RVs for PSSCHs 311-313 are RV0, RV2 and RV3, respectively, RVs for PSSCHs 314-316 are RV0, RV2 and RV3, respectively, and RVs for PSSCHs 317 and 318 are RV0 and RV2, respectively. Assuming that SCI 321 indicates RV2, then according to the RV pattern, RVs for PSSCHs 311-313 are RV2, RV3 and RV1, respectively, RVs for PSSCHs 314-316 are RV2, RV3 and RV1, respectively, and RVs for PSSCHs 317 and 318 are RV2 and RV3, respectively.

In the above example, since the number of RVs within the configured RV pattern is larger than the number of transmissions of each TB, some RV values are not used. For example, RV1 may not be used for TB #1 and TB #2, and both RV3 and RV1 may not be used for TB #3. In some examples, an RV pattern with less RV values may be employed. For example, RV patterns {0/2/3}, {0/2}, {0/3}, and {0/0} can be employed to be adapted to the number of PSSCHs for a TB.

In some embodiments of the present disclosure, the SCI may indicate an RV pattern for the set of PSSCHs which carry the same TB. The RV(s) for the PSSCH(s) of the set of PSSCHs may follow the RV pattern in order. In some examples, the RV pattern may be indicated by the SCI from a set of RV patterns. The set of RV patterns may be configured by RRC signaling, predefined, or preconfigured for the UE. In this way, a UE may know the RV pattern used for the scheduled PSSCHs.

In some examples, possible RV patterns can include {0/2/3/1}, {0/3/0/3}, or {0/0/0/0}. In some examples, possible RV patterns can include {0/2/3}, {0/2}, {0/3}, or {0/0}. In some cases, the number of RVs within the indicated RV pattern may be larger than the number of PSSCHs for a TB. In such cases, one or more RVs within the indicated RV pattern may not be used for the set of PSSCHs carrying the TB. In some cases, the number of RVs within the indicated RV pattern may be smaller than the number of PSSCHs for a TB, and the RV pattern may be repeatedly applied to the number of PSSCHs carrying the same TB.

For example, referring again to FIG. 3, it is assumed that TB #1 is repeatedly transmitted on PSSCHs 311-313, TB #2 is repeatedly transmitted on PSSCHs 314-316, TB #3 is repeatedly transmitted on PSSCHs 317 and 318, and SCI 321 indicates RV pattern {0/2/3/1}. Then according to the indicated RV pattern, RVs for PSSCHs 311-313 are RV0, RV2 and RV3, respectively, RVs for PSSCHs 314-316 are RV0, RV2 and RV3, respectively, and RVs for PSSCHs 317 and 318 are RV0 and RV2, respectively.

In the above example, since the number of RVs within the indicated RV pattern is larger than the number of transmissions of each TB, some RV values are not used. For example, RV1 may not be used for TB #1 and TB #2, and both RV3 and RV1 may not be used for TB #3. In some examples, an RV pattern with less RV values may be employed. For example, RV patterns {0/2/3}, {0/2}, {0/3}, and {0/0} can be employed to be adapted to the number of PSSCHs for a TB. In this way, no RV is unused in the above multiple scheduled PSSCHs.

In some embodiments of the present disclosure, the HARQ-ACK feedback for the plurality of PSSCHs scheduled by SCI #1 may be based on indicator #1. That is, the number of the HARQ-ACK information bits for the plurality of scheduled PSSCHs may be based on the number of the at least one TB. For example, when X TBs are transmitted on Y PSSCHs scheduled by SCI #1, the number of HARQ-ACK information bits for the Y scheduled PSSCHs may be equal to X. For a TB transmitted on one or more PSSCHs, as long as one PSSCH of the one or more PSSCHs is correctly received or decoded, then an acknowledgement (ACK) is generated for the TB. When none of the one or more PSSCHs is correctly received or decoded, a negative ACK (NACK) is generated for the TB. In some examples, an Rx UE may transmit the HARQ-ACK information bits according to, for example, the HARQ-ACK feedback option. For example, when ACK/NACK based feedback is employed, the Rx UE may transmit the HARQ-ACK information bits (e.g., ACK or NACK) for the Y scheduled PSSCHs. When NACK-only based feedback is employed, the Rx UE may only transmit a HARQ-ACK information bit for a TB when a NACK is generated for the TB.

In some embodiments, a SCI may be transmitted in two stages, wherein the 1^{st}-stage SCI may be carried on a PSCCH and the 2^{nd}-stage SCI may be carried (or multiplexed) on the scheduled PSSCH. To put another way, the 1^{st}-stage SCI schedules the 2^{nd}-stage SCI and the PSSCH. The specific definitions of the 1st-stage SCI and 2^{nd}-stage SCI can be referred to in 3GPP specifications.

In some embodiments of the present disclosure, the 2^{nd}-stage SCI may only be multiplexed on a specific PSSCH (e.g., the first scheduled PSSCH) of the plurality of PSSCHs scheduled by the 1^{st}-stage SCI. In some embodiments of the present disclosure, the 2^{nd}-stage SCI may be multiplexed on each of the plurality of PSSCHs or a set of PSSCHs of the plurality of PSSCHs, which can improve reliability, especially when the 2^{nd}-stage SCI is of large payload size for different TBs transmitted on the plurality of scheduled PSSCHs.

There are various scenarios regarding the SCI format and the payload size determination of 1^{st}-stage SCI and 2^{nd}-stage SCI.

In some embodiments of the present disclosure, the 1^{st}-stage SCI may include indicator #1, and the payload size of the second SCI may be determined based on: the number of the at least one TB (e.g., X), the maximum number of TBs schedulable by the 1^{st}-stage SCI (e.g., M), or indicator #1 and the maximum number of TBs schedulable by the 1^{st}-stage SCI (e.g., M).

For example, in some embodiments of the present disclosure, indicator #1 may be included in the 1^{st}-stage SCI. The payload size of the 2^{nd}-stage SCI may vary according to the number of scheduled TBs.

For example, it is assumed that X TBs are scheduled on Y PSSCHs by a SCI, then without consideration of 2^{nd}-stage SCI overhead reduction, the 2^{nd}-stage SCI may include, for example, 4×X bits for HARQ process numbers with (for example) every 4 consecutive bits corresponding to one TB (assuming that a maximum of 16 HARQ process numbers is supported), X bits for a new data indicator (NDI) with each bit corresponding to one TB, 2×X bits for RVs with (for example) every 2 consecutive bits corresponding to one TB (assuming that a maximum of 4 RVs is supported), and other necessary fields, such as 1 bit for a channel state information (CSI) request.

In some examples, considering the plurality of scheduled PSSCHs (or TBs) are transmitted from the same Tx UE, a source ID (e.g., 8 bits) may be included in the 2^{nd}-stage SCI and common to all the scheduled PSSCHs (or TBs). Similarly, a zone ID (e.g., 12 bits) may be included in the 2^{nd}-stage SCI and common for all the scheduled PSSCHs (or TBs).

In some examples, when all the scheduled TBs are targeted for the same destination, a destination ID (e.g., 16 bits) may be included in the 2^{nd}-stage SCI and common to all the scheduled TBs. Otherwise, when the X TBs are targeted for different destinations, 16×X bits may be needed in the 2^{nd}-stage SCI with (for example) every 16 consecutive bits corresponding to one destination ID for each of the scheduled TBs.

In some examples, when all the scheduled TBs can only have the same HARQ enabling/disabling option, a single HARQ enabling/disabling indicator (e.g., 1 bit) may be included in the 2^{nd}-stage SCI and common to all the scheduled TBs. Otherwise, X bits may be needed in the 2^{nd}-stage SCI with (for example) each bit corresponding to one of the scheduled TBs.

In some examples, when all the scheduled TBs can only have the same cast type, a single cast type indicator (e.g., 2 bits) may be included in the 2^{nd}-stage SCI and common to all the scheduled TBs. Otherwise, 2×X bits may be needed in the 2^{nd}-stage SCI with (for example) every two consecutive bits corresponding to one of the scheduled TBs.

In some examples, when all the scheduled TBs are only targeted for the same service, a single communication range requirements indicator (e.g., 4 bits) may be included in the 2^{nd}-stage SCI and common to all the scheduled TBs. Otherwise, 4×X bits may be needed in the 2^{nd}-stage SCI with (for example) every four consecutive bits corresponding to one of the scheduled TBs.

In some embodiments, the sizes of the fields related to HARQ enabling/disabling, destination ID, cast types and communication range requirements may be dependent on whether different HARQ enabling/disabling, destination IDs, cast types or services co-scheduled by a single SCI is allowed. For example, in the case that different HARQ enabling/disabling for the TBs scheduled by a single SCI is not supported, the field for the HARQ enabling/disabling indicator may include 1 bit; otherwise, the field for the HARQ enabling/disabling indicator may be assumed as X bits.

Table 1a below shows an exemplary format of 2^{nd}-stage SCI. It should be understood that Table 1a is only for illustrative purposes, and should not be construed as limiting the embodiments of the present disclosure.

TABLE 1a
Exemplary format of 2^{nd}-stage SCI

| 2nd-stage SCI | Bit size (assuming X TBs are scheduled) |
|---|---|
| HARQ process | 4 × X bits |
| number (HPN) | |
| NDI | X bits |
| RV | 2 × X bits |
| Source ID | 8 bits, common to all scheduled TBs |
| Destination ID | 16 bits if all scheduled TBs are only targeted |
| | for the same destination; or |
| | 16 × X bits if all scheduled TBs can be |
| | targeted for different destinations. |
| HARQ enabling/disabling | 1 bit if all scheduled TBs can only have the |
| | same HARQ enabling/disabling; or |
| | X bits if all scheduled TBs can have |
| | different HARQ enabling/disabling. |
| Cast type indicator | 2 bits if all scheduled TBs can only have the |
| | same cast type; or |
| | 2 × X bits if all scheduled TBs can have |
| | different cast types. |
| CSI request | 1 bit, a single bit is enough to trigger a CSI |
| | request |
| Zone ID | 12 bits, common to all scheduled TBs |
| Communication range | 4 bits common to all scheduled TBs if all |
| requirements | scheduled TBs are targeted for the same |
| | service; or |
| | 4 × X bits separate to all scheduled TBs if all |
| | scheduled TBs can be targeted for different |
| | services. |

In some embodiments of the present disclosure, indicator #1 may be included in the 1^{st}-stage SCI. The payload size of the 2^{nd}-stage SCI may be kept the same regardless of the number of scheduled TBs or PSSCHs. For example, the payload size of the 2^{nd}-stage SCI may be determined based on the maximum number of TBs (or PSSCHs) schedulable by a single SCI (e.g., 1^{st}-stage SCI). The maximum number of TBs (or PSSCHs) schedulable by a single SCI (e.g., M) may be configured by RRC signaling or predefined in, for example, a standard(s).

For example, it is assumed that a maximum of M TBs can be jointly scheduled by a single SCI, then without consideration of 2^{nd}-stage SCI overhead reduction, the 2^{nd}-stage SCI may include, for example, 4×M bits for HARQ process number with (for example) every 4 consecutive bits corresponding to one TB (assuming that a maximum of 16 HARQ process numbers is supported), M bits for a NDI with each bit corresponding to one TB, 2×M bits for RVs with (for example) every 2 consecutive bits corresponding to one TB (assuming that a maximum of 4 RVs is supported), and other necessary fields, such as 1 bit for a CSI request.

In some examples, considering the plurality of scheduled PSSCHs (or TBs) are transmitted from the same Tx UE, a source ID (e.g., 8 bits) may be included in the 2^{nd}-stage SCI and common to all the scheduled PSSCHs (or TBs). Similarly, a zone ID (e.g., 12 bits) may be included in the 2^{nd}-stage SCI and common for all the scheduled PSSCHs (or TBs).

In some examples, when all the scheduled TBs are targeted for the same destination, a destination ID (e.g., 16 bits) may be included in the 2^{nd}-stage SCI and common to all the scheduled TBs. Otherwise, 16×M bits may be needed in the 2^{nd}-stage SCI with (for example) every 16 consecutive bits corresponding to one destination ID for one of the maximum M scheduled TBs.

In some examples, when all the scheduled TBs can only have the same HARQ enabling/disabling option, a single HARQ enabling/disabling indicator (e.g., 1 bit) may be included in the 2^{nd}-stage SCI and common to all the scheduled TBs. Otherwise, M bits may be needed in the 2^{nd}-stage SCI with (for example) each bit corresponding to one of the maximum M scheduled TBs.

In some examples, when all the scheduled TBs can only have the same cast type, a single cast type indicator (e.g., 2 bits) may be included in the 2^{nd}-stage SCI and common to all the scheduled TBs. Otherwise, 2×M bits may be needed in the 2^{nd}-stage SCI with (for example) every two consecutive bits corresponding to one of the maximum M scheduled TBs.

In some examples, when all the scheduled TBs are only targeted for the same service, a single communication range requirements indicator (e.g., 4 bits) may be included in the 2^{nd}-stage SCI and common to all the scheduled TBs. Otherwise, 4×M bits may be needed in the 2^{nd}-stage SCI with (for example) every four consecutive bits corresponding to one of the maximum M scheduled TBs.

In some embodiments, the sizes of the fields related to HARQ enabling/disabling, destination ID, cast types and communication range requirements may be dependent on whether different HARQ enabling/disabling, destination IDs, cast types or services co-scheduled by a single SCI is allowed.

Table 1b below shows an exemplary format of 2^{nd}-stage SCI. It should be understood that Table 1b is only for illustrative purposes, and should not be construed as limiting the embodiments of the present disclosure.

TABLE 1b
Exemplary format of 2^{nd}-stage SCI

| | Bit size (assuming that max M TBs can be |
|---|---|
| 2nd-stage SCI | jointly scheduled by a single SCI) |
| HPN | 4 × M bits |
| NDI | M bits |
| RV | 2 × M bits |
| Source ID | 8 bits, common to all scheduled TBs |
| Destination ID | 16 bits if all scheduled TBs are only targeted |
| | for the same destination; or |
| | 16 × M bits if all scheduled TBs can be |
| | targeted for different destinations. |
| HARQ | 1 bit if all scheduled TBs can only have the |
| enabling/disabling | same HARQ enabling/disabling; or |
| | M bits if all scheduled TBs can have different |
| | HARQ enabling/disabling. |
| Cast type indicator | 2 bits if all scheduled TBs can only have the |
| | same cast type; or |
| | 2 × M bits if all scheduled TBs can have |
| | different cast types. |
| CSI request | 1 bit, a single bit is enough to trigger a CSI |
| | request |
| Zone ID | 12 bits, common to all scheduled TBs |
| Communication range | 4 bits common to all scheduled TBs if all |
| requirements | scheduled TBs are targeted for the same |
| | service; or |
| | 4 × M bits separate to all scheduled TBs if all |
| | scheduled TBs can be targeted for different |
| | services. |

In some embodiments of the present disclosure, indicator #1 may be included in the 1^{st}-stage SCI. There are two payload sizes of the 2^{nd}-stage SCI: payload size #1 is the same as that of a single-PSSCH scheduling SCI and is applied when indicator #1 indicates that the number of scheduled TBs is equal to 1; and payload size #2 is determined based on the maximum number of TBs (or PSSCHs) schedulable by a single SCI (e.g., M) and is applied when indicator #1 indicates that the number of scheduled TBs is larger than 1. The maximum number of TBs (or PSSCHs) schedulable by a single SCI (e.g., M) may be configured by RRC signaling or predefined in, for example, a standard(s).

In the case that indicator #1 indicates that the number of scheduled TBs is equal to 1, payload size #1 of the 2^{nd}-stage SCI may be predefined in a standard(s). For example, the 2^{nd}-stage SCI may include a 4-bit HARQ process number, a 1-bit NDI, a 2-bit RV, an 8-bit source ID, a 16-bit destination ID, a 1-bit HARQ enabling/disabling, a 2-bit cast type indicator for the single TB, and other necessary fields, such as a field for a CSI request.

In the case that indicator #1 indicates that the number of scheduled TBs is larger than 1, payload size #2 of the 2^{nd}-stage SCI may be determined according to the maximum number of TBs schedulable by a single SCI, with TB-specific fields assumed and included in the 2^{nd}-stage SCI.

For example, it is assumed that a maximum of M TBs can be jointly scheduled by a single SCI, then without consideration of 2^{nd}-stage SCI overhead reduction, the 2^{nd}-stage SCI may include, for example, 4×M bits for HARQ process number with (for example) every 4 consecutive bits corresponding to one TB (assuming that a maximum of 16 HARQ process numbers is supported), M bits for a NDI with each bit corresponding to one TB, 2×M bits for RVs with (for example) every 2 consecutive bits corresponding to one TB (assuming that a maximum of 4 RVs is supported), and other necessary fields, such as 1 bit for a CSI request.

In some examples, considering the plurality of scheduled PSSCHs (or TBs) are transmitted from the same Tx UE, a source ID (e.g., 8 bits) may be included in the 2^{nd}-stage SCI and common to all the scheduled PSSCHs (or TBs). Similarly, a zone ID (e.g., 12 bits) may be included in the 2^{nd}-stage SCI and common for all the scheduled PSSCHs (or TBs).

In some examples, when all the scheduled TBs are targeted for the same destination, a destination ID (e.g., 16 bits) may be included in the 2^{nd}-stage SCI and common to all the scheduled TBs. Otherwise, 16×M bits may be needed in the 2^{nd}-stage SCI with (for example) every 16 consecutive bits corresponding to one destination ID for one of the maximum M scheduled TBs.

In some examples, when all the scheduled TBs can only have the same HARQ enabling/disabling option, a single HARQ enabling/disabling indicator (e.g., 1 bit) may be included in the 2^{nd}-stage SCI and common to all the scheduled TBs. Otherwise, M bits may be needed in the 2^{nd}-stage SCI with (for example) each bit corresponding to one of the maximum M scheduled TBs.

In some examples, when all the scheduled TBs can only have the same cast type, a single cast type indicator (e.g., 2 bits) may be included in the 2^{nd}-stage SCI and common to all the scheduled TBs. Otherwise, 2×M bits may be needed in the 2^{nd}-stage SCI with (for example) every two consecutive bits corresponding to one of the maximum M scheduled TBs.

In some examples, when all the scheduled TBs are only targeted for the same service, a single communication range requirements indicator (e.g., 4 bits) may be included in the 2^{nd}-stage SCI and common to all the scheduled TBs. Otherwise, 4×M bits may be needed in the 2^{nd}-stage SCI with (for example) every four consecutive bits corresponding to one of the maximum M scheduled TBs.

In some embodiments, the sizes of the fields related to HARQ enabling/disabling, destination ID, cast types and communication range requirements may be dependent on whether different HARQ enabling/disabling, destination IDs, cast types or services co-scheduled by a single SCI is allowed.

Table 1c below shows an exemplary format of 2^{st}-stage SCI. It should be understood that Table 1c is only for illustrative purposes, and should not be construed as limiting the embodiments of the present disclosure.

TABLE 1c
Exemplary format of 2^{nd}-stage SCI

| | Bit size | | |
|---|---|---|---|
| | (single | | Bit size (assuming that max M TBs can |
| 2nd-stage SCI | TB) | | be jointly scheduled by a single SCI) |
| HPN | 4 | bits | 4 × M bits |
| NDI | 1 | bit | M bits |
| RV | 2 | bits | 2 × M bits |
| Source ID | 8 | bits | 8 bits, common to all scheduled TBs |
| Destination ID | 16 | bits | 16 bits if all scheduled TBs are only |
| | | | targeted for the same destination; or |
| | | | 16 × M bits if all scheduled TBs can be |
| | | | targeted for different destinations. |
| HARQ | 1 | bit | 1 bit if all scheduled TBs can only have |
| enabling/disabling | | | the same HARQ enabling/disabling; or |
| | | | M bits if all scheduled TBs can have |
| | | | different HARQ enabling/disabling. |
| Cast type | 2 | bits | 2 bits if all scheduled TBs can only have |
| indicator | | | the same cast type; or |
| | | | 2 × M bits if all scheduled TBs can have |
| | | | different cast types. |
| CSI request | 1 | bit | 1 bit, a single bit is enough to trigger a |
| | | | CSI request |
| Zone ID | 12 | bits | 12 bits, common to all scheduled TBs |
| Communication | 4 | bits | 4 bits common to all scheduled TBs if |
| range | | | all scheduled TBs are targeted for the |
| requirements | | | same service; or |
| | | | 4 × M bits separate to all scheduled TBs |
| | | | if all scheduled TBs can be targeted |
| | | | for different services. |

In some embodiments of the present disclosure, indicator #1 may be included in the 2^{nd}-stage SCI. The payload size of the 2^{nd}-stage SCI may be kept the same regardless of the number of scheduled TBs or PSSCHs. For example, the payload size of the 2^{nd}-stage SCI may be determined based on the maximum number of TBs (or PSSCHs) schedulable by a single SCI (e.g., 1^{st}-stage SCI or 2^{nd}-stage SCI). The maximum number of TBs (or PSSCHs) schedulable by a single SCI (e.g., M) may be configured by RRC signaling or predefined in, for example, a standard(s).

For example, it is assumed that a maximum of M TBs can be jointly scheduled by a single SCI, then without consideration of 2^{nd}-stage SCI overhead reduction, the 2^{nd}-stage SCI may include, for example, 4×M bits for HARQ process number with (for example) every 4 consecutive bits corresponding to one TB (assuming that a maximum of 16 HARQ process numbers is supported), M bits for a NDI with each bit corresponding to one TB, 2×M bits for RVs with (for example) every 2 consecutive bits corresponding to one TB (assuming that a maximum of 4 RVs is supported), and other necessary fields, such as 1 bit for a CSI request.

In some examples, considering the plurality of scheduled PSSCHs (or TBs) are transmitted from the same Tx UE, a source ID (e.g., 8 bits) may be included in the 2^{nd}-stage SCI and common to all the scheduled PSSCHs (or TBs). Similarly, a zone ID (e.g., 12 bits) may be included in the 2^{nd}-stage SCI and common for all the scheduled PSSCHs (or TBs).

In some examples, when all the scheduled TBs are targeted for the same destination, a destination ID (e.g., 16 bits) may be included in the 2^{nd}-stage SCI and common to all the scheduled TBs. Otherwise, 16×M bits may be needed in the 2^{nd}-stage SCI with (for example) every 16 consecutive bits corresponding to one destination ID for one of the maximum M scheduled TBs.

In some examples, when all the scheduled TBs can only have the same HARQ enabling/disabling option, a single HARQ enabling/disabling indicator (e.g., 1 bit) may be included in the 2^{nd}-stage SCI and common to all the scheduled TBs. Otherwise, M bits may be needed in the 2^{nd}-stage SCI with (for example) each bit corresponding to one of the maximum M scheduled TBs.

In some examples, when all the scheduled TBs can only have the same cast type, a single cast type indicator (e.g., 2 bits) may be included in the 2^{nd}-stage SCI and common to all the scheduled TBs. Otherwise, 2×M bits may be needed in the 2^{nd}-stage SCI with (for example) every two consecutive bits corresponding to one of the maximum M scheduled TBs.

In some examples, when all the scheduled TBs are only targeted for the same service, a single communication range requirements indicator (e.g., 4 bits) may be included in the 2^{nd}-stage SCI and common to all the scheduled TBs. Otherwise, 4×M bits may be needed in the 2^{nd}-stage SCI with (for example) every four consecutive bits corresponding to one of the maximum M scheduled TBs.

In some embodiments, the sizes of the fields related to HARQ enabling/disabling, destination ID, cast types and communication range requirements may be dependent on whether different HARQ enabling/disabling, destination IDs, cast types or services co-scheduled by a single SCI is allowed.

Table 1d below shows an exemplary format of 2^{nd}-stage SCI. The exemplary SCI format in Table 1d includes an indicator indicating the number of TBs transmitted on the plurality of scheduled PSSCHs. It should be understood that Table 1d is only for illustrative purposes, and should not be construed as limiting the embodiments of the present disclosure.

TABLE 1d
Exemplary format of 2nd-stage SCI

| | Bit size (assuming that max M TBs can be |
|---|---|
| 2^{nd}-stage SCI | jointly scheduled by a single SCI) |
| Indicator of the | [log₂ M] bits |
| number of | |
| scheduled TBs | |
| HPN | 4 × M bits |
| NDI | M bits |
| RV | 2 × M bits |
| Source ID | 8 bits, common to all scheduled TBs |
| Destination ID | 16 bits if all scheduled TBs are only targeted |
| | for the same destination; or |
| | 16 × M bits if all scheduled TBs can be |
| | targeted for different destinations. |
| HARQ | 1 bit if all scheduled TBs can only have the |
| enabling/disabling | same HARQ enabling/disabling; or |
| | M bits if all scheduled TBs can have different |
| | HARQ enabling/disabling. |
| Cast type indicator | 2 bits if all scheduled TBs can only have the |
| | same cast type; or |
| | 2 × M bits if all scheduled TBs can have |
| | different cast types. |
| CSI request | 1 bit, a single bit is enough to trigger a CSI |
| | request |
| Zone ID | 12 bits, common to all scheduled TBs |
| Communication | 4 bits common to all scheduled TBs if all |
| range | scheduled TBs are targeted for the same |
| requirements | service; or |
| | 4 × M bits separate to all scheduled TBs if all |
| | scheduled TBs can be targeted for different |
| | services. |

From the perspective of a Tx UE, it can flexibly adjust its transmission policy. For example, the Tx UE can transmit a single TB repetition or multiple TBs on the plurality of co-scheduled PSSCHs for different purposes. The Tx UE may determine the payload size of the SCI (e.g., 1^{st}-stage SCI and 2^{nd}-stage SCI) according to one of the aforementioned embodiments and transmit the SCI (e.g., 1^{st}-stage SCI and 2^{nd}-stage SCI) to an Rx UE(s).

From the perspective of an Rx UE, it may monitor a SCI based on the SCI payload size determination methods as described above. In response to receiving a plurality of PSSCHs scheduled by a single SCI, the Rx UE may check indicator #1 to determine the number of actually scheduled TBs, map the scheduled TBs on the scheduled PSSCHs, and generate HARQ-ACK information bits for the scheduled TBs based on the number of actually scheduled TBs.

In some embodiments of the present disclosure, an indicator (denoted as indicator #2) in a SCI (denoted as SCI #2) may indicate whether a single TB is repeated on the plurality of PSSCHs scheduled by SCI #2 or each of the plurality of scheduled PSSCHs carries a different TB.

Based on indicator #2, a UE can determine whether the number of scheduled TB (denoted as X) is equal to 1 or equal to the number of scheduled PSSCHs (denoted as N). In some embodiments, the number of PSSCHs scheduled by a SCI can be determined according to various manners. For example, it can be directly indicated, for example, by the SCI or RRC signaling, or implicitly derived based on SLIVs in a TDRA table.

In some embodiments, indicator #2 may be specific for multi-PSSCH scheduling. For example, indicator #2 may be a new field introduced for indicating whether a single TB is repeated or different TBs are transmitted. For example, the value of “1” (or the value of “0”) may indicate that a single TB is repeated on the plurality of scheduled PSSCHs. For example, all the scheduled PSSCHs carry the same TB for reliability enhancement. The value of “0” (or the value of “1”) may indicate that multiple different TBs are transmitted on the plurality of scheduled PSSCHs. For example, each of the plurality of scheduled PSSCHs is used for transmitting a different TB for high data rate purpose.

In some embodiments, indicator #2 may reuse a field in the SCI for indicating whether a single TB is repeated or different TBs are transmitted. For example, an SCI format indicator in the SCI (e.g., in the 1^{st}-stage SCI) may be reused as indicator #2. To put another way, indicator #2 may indicate two SCI formats (e.g., two 2^{nd}-stage SCI formats): one SCI format is used for repeating a single TB on the plurality of scheduled PSSCHs, and another SCI format is used for transmitting multiple different TBs on the plurality of scheduled PSSCHs. For example, new code points of the SCI format indicator may be used to indicate the above two SCI formats.

When the same TB repetition is transmitted on the plurality of scheduled PSSCHs, an ordering of the RVs (also referred to as an RV pattern) for the same TB repetition on the plurality of PSSCHs may need to be defined.

In some embodiments of the present disclosure, SCI #2 may include an RV indicator to indicate a single RV (denoted as RV #2). RV #2 may correspond to a specific PSSCH (e.g., the first scheduled PSSCH) of the plurality of PSSCHs which carry the same TB. The RV(s) for the remaining PSSCH(s) of the plurality of PSSCHs may follow RV #2 based on an RV pattern. In some examples, the RV pattern may be configured by RRC signaling, predefined, or preconfigured for the UE. In some examples, the RV pattern may be indicated by the SCI from a set of RV patterns. The set of RV patterns may be configured by RRC signaling, predefined, or preconfigured for the UE. In this way, a UE may know the RV pattern used for the scheduled PSSCHs.

In some examples, possible RV patterns can include {0/2/3/1}, {0/3/0/3}, or {0/0/0/0}. In some examples, possible RV patterns can include {0/2/3}, {0/2}, {0/3}, or {0/0}. In some cases, the number of RVs within an RV pattern may be larger than the number of PSSCHs for a TB, especially when the TB has fewer transmissions than the other TBs scheduled by the same SCI. In such cases, one or more RVs within the determined RV pattern may not be used for the plurality of PSSCHs carrying the TB. In some cases, the number of RVs within an RV pattern may be smaller than the number of PSSCHs for a TB, and the RV pattern may be repeatedly applied to the number of PSSCHs carrying the same TB. For example, assuming that RV pattern {0/2/3} is used and there are five PSSCHs carrying the same TB, the RVs for the five PSSCHs may be RV0, RV2, RV3, RV0, and RV2.

For example, in some embodiments, the RV pattern may be configured by RRC signaling, for example, from a set of possible RV patterns, for a UE. The UE may transmit a SCI scheduling a plurality of PSSCHs carrying the same TB. Assuming that TB #A2 is repeatedly transmitted on PSSCH #1′, PSSCH #2′ and PSSCH #3′ and the configured RV pattern is {0/2/3/1}, the SCI may indicate a single RV (e.g., RV0) which correspond PSSCH #1′. Then, RVs for PSSCH #2′ and PSSCH #3′ may be RV2 and RV3, respectively, according to the configured RV pattern.

For example, referring again to FIG. 3, it is assumed that TB #1 is repeatedly transmitted on PSSCHs 311-318 and the configured RV pattern is {0/2/3/1}. Assuming that SCI 321 indicates RV0, then according to the RV pattern, RVs for PSSCHs 311-318 are RV0, RV2, RV3, RV1, RV0, RV2, RV3, and RV1, respectively. Assuming that SCI 321 indicates RV2, then according to the RV pattern, RVs for PSSCHs 311-318 are RV2, RV3, RV1, RV0, RV2, RV3, RV1, and RV0, respectively.

In the above example, since the number of RVs within the configured RV pattern is smaller than the number of transmissions of the TB, the RV pattern may be repeatedly applied to the plurality of PSSCHs carrying the same TB. In some cases, the number of RVs within the RV pattern may be larger than the number of PSSCHs for a TB. In such cases, one or more RVs within the RV pattern may not be used for the plurality of PSSCHs carrying the same TB. In some examples, an RV pattern with more or less RV values may be employed. For example, RV patterns {0/2/3}, {0/2}, {0/3}, and {0/0} can be employed.

In some embodiments of the present disclosure, the SCI may indicate an RV pattern for the plurality of PSSCHs which carry the same TB. The RV(s) for the PSSCH(s) of the plurality of PSSCHs may follow the RV pattern in order. In some examples, the RV pattern may be indicated by the SCI from a set of RV patterns. The set of RV patterns may be configured by RRC signaling, predefined, or preconfigured for the UE. In this way, a UE may know the RV pattern used for the scheduled PSSCHs.

In some examples, possible RV patterns can include {0/2/3/1}, {0/3/0/3}, or {0/0/0/0}. In some examples, possible RV patterns can include {0/2/3}, {0/2}, {0/3}, or {0/0}. In some cases, the number of RVs within the indicated RV pattern may be larger than the number of PSSCHs for a TB. In such cases, one or more RVs within the indicated RV pattern may not be used for the plurality of PSSCHs carrying the TB. In some cases, the number of RVs within the indicated RV pattern may be smaller than the number of PSSCHs for a TB, and the RV pattern may be repeatedly applied to the plurality of PSSCHs carrying the same TB.

For example, referring again to FIG. 3, it is assumed that TB #1 is repeatedly transmitted on PSSCHs 311-318 and SCI 321 indicates RV pattern {0/2/3/1}. Then according to the indicated RV pattern, RVs for PSSCHs 311-318 are RV0, RV2, RV3, RV1, RV0, RV2, RV3, and RV1, respectively.

In the above example, since the number of RVs within the indicated RV pattern is smaller than the number of transmissions of the TB, the RV pattern may be repeatedly applied to the plurality of PSSCHs carrying the same TB. In some cases, the number of RVs within the RV pattern may be larger than the number of PSSCHs for a TB, and thus some RV values may not be used. In some examples, an RV pattern with more or less RV values may be employed. For example, RV patterns {0/2/3}, {0/2}, {0/3}, and {0/0} can be employed to be adapted to the number of PSSCHs for a TB. In this way, no RV is unused in the above multiple scheduled PSSCHs.

In some embodiments of the present disclosure, the HARQ-ACK feedback for the plurality of PSSCHs scheduled by SCI #2 may be based on indicator #2.

For example, when indicator #2 indicates that a single TB is repeated on the plurality of scheduled PSSCHs, the number of HARQ-ACK information bits for the plurality of scheduled PSSCHs may be 1 regardless of the number of scheduled PSSCHs. For example, as long as one PSSCH of the plurality of PSSCHs is correctly received or decoded, then an ACK is generated for the single TB. When none of the plurality of PSSCHs is correctly received or decoded, a NACK is generated for the single TB.

For example, when indicator #2 indicates that each of the plurality of scheduled PSSCHs carries a different TB, the number of the HARQ-ACK information bits for the plurality of scheduled PSSCHs may be based on the number of scheduled TBs or PSSCHs. For example, when X TBs are transmitted on N PSSCHs scheduled by SCI #2 (X=N), the number of HARQ-ACK information bits for the X (or N) TBs or PSSCHs may be equal to X (or N), with one HARQ-ACK information bit corresponding to one TB or PSSCH.

In some embodiments, SCI #2 may be transmitted in a 1^{st}-stage SCI and a 2^{nd}-stage SCI. The specific definitions of the 1^{st}-stage SCI and 2^{nd}-stage SCI can be referred to in 3GPP specifications.

In some embodiments of the present disclosure, the 2^{nd}-stage SCI may only be multiplexed on a specific PSSCH (e.g., the first scheduled PSSCH) of the plurality of PSSCHs scheduled by the 1^{st}-stage SCI. In some embodiments of the present disclosure, the 2^{nd}-stage SCI may be multiplexed on each of the plurality of PSSCHs or a set of PSSCHs of the plurality of PSSCHs, which can improve reliability, especially when the 2^{nd}-stage SCI is of large payload size for different TBs transmitted on the plurality of scheduled PSSCHs.

There are various scenarios regarding the SCI format and the payload size determination of 1^{st}-stage SCI and 2^{nd}-stage SCI.

In some embodiments of the present disclosure, the 1^{st}-stage SCI may include indicator #2, and the payload size of the second SCI may be determined based on: the number of scheduled TBs (e.g., X), the maximum number of TBs schedulable by the 1^{st}-stage SCI (e.g., M), or indicator #2 and the maximum number of TBs schedulable by the 1^{st}-stage SCI (e.g., M).

For example, in some embodiments of the present disclosure, indicator #2 may be included in the 1^{st}-stage SCI. The payload size of the 1^{st}-stage SCI when the 1^{st}-stage SCI indicates a single TB is repeated on the plurality of scheduled PSSCHs is the same as that when multiple TBs are transmitted on the plurality of scheduled PSSCHs. The payload size of the 2^{nd}-stage SCI may be determined according to the number of scheduled TBs.

For example, when indicator #2 indicates that a single TB is repeated on the plurality of scheduled PSSCHs (e.g., X=1), the payload size of the 2^{nd}-stage SCI is the same as that of a single-PSSCH scheduling SCI. For example, the payload size may be predefined in a standard(s). For example, the 2^{nd}-stage SCI may include a 4-bit HARQ process number, a 1-bit NDI, a 2-bit RV, an 8-bit source ID, a 16-bit destination ID, a 1-bit HARQ enabling/disabling, a 2-bit cast type indicator for the single TB, and other necessary fields, such as a field for a CSI request.

When indicator #2 indicates that each of the plurality of scheduled PSSCHs carries a different TB (e.g., X=N), the payload size of the 2^{nd}-stage SCI may vary according to the number of scheduled TBs (or PSSCHs) because TB-specific fields are assumed and included in the 2^{nd}-stage SCI.

For example, it is assumed that N PSSCHs are jointly scheduled by a SCI, then without consideration of 2^{nd}-stage SCI overhead reduction, the 2^{nd}-stage SCI may include, for example, 4×N bits for HARQ process number with every (for example) 4 consecutive bits corresponding to one PSSCH or TB (assuming that a maximum of 16 HARQ process numbers is supported), N bits for a NDI with each bit corresponding to one PSSCH or TB, 2×N bits for RV with (for example) every 2 consecutive bits corresponding to one PSSCH or TB (assuming that a maximum of 4 RVs is supported), and other necessary fields, such as a field for a CSI request.

In some examples, considering the plurality of scheduled PSSCHs (or TBs) are transmitted from the same Tx UE, a source ID (e.g., 8 bits) may be included in the 2^{nd}-stage SCI and common to all the scheduled PSSCHs (or TBs). Similarly, a zone ID (e.g., 12 bits) may be included in the 2^{nd}-stage SCI and common for all the scheduled PSSCHs (or TBs).

In some examples, when all the scheduled TBs are targeted for the same destination, a destination ID (e.g., 16 bits) may be included in the 2^{nd}-stage SCI and common to all the scheduled TBs. Otherwise, 16×N bits may be needed in the 2^{nd}-stage SCI with (for example) every 16 consecutive bits corresponding to one destination ID for one of the maximum N scheduled TBs.

In some examples, when all the scheduled TBs can only have the same HARQ enabling/disabling option, a single HARQ enabling/disabling indicator (e.g., 1 bit) may be included in the 2^{nd}-stage SCI and common to all the scheduled TBs. Otherwise, N bits may be needed in the 2^{nd}-stage SCI with (for example) each bit corresponding to one of the N scheduled TBs.

In some examples, when all the scheduled TBs can only have the same cast type, a single cast type indicator (e.g., 2 bits) may be included in the 2^{nd}-stage SCI and common to all the scheduled TBs. Otherwise, 2×N bits may be needed in the 2^{nd}-stage SCI with (for example) every two consecutive bits corresponding to one of the N scheduled TBs.

In some examples, when all the scheduled TBs are only targeted for the same service, a single communication range requirements indicator (e.g., 4 bits) may be included in the 2^{nd}-stage SCI and common to all the scheduled TBs. Otherwise, 4×N bits may be needed in the 2^{nd}-stage SCI with (for example) every four consecutive bits corresponding to one of the N scheduled TBs.

In some embodiments, the sizes of the fields related to HARQ enabling/disabling, destination ID, cast types and communication range requirements may be dependent on whether different HARQ enabling/disabling, destination IDs, cast types or services co-scheduled by a single SCI is allowed.

Table 2a below shows an exemplary format of 2^{nd}-stage SCI. It should be understood that Table 2a is only for illustrative purposes, and should not be construed as limiting the embodiments of the present disclosure.

TABLE 2a
Exemplary format of 2^{nd}-stage SCI

| | | | Bit size (multiple different TBs on |
|---|---|---|---|
| | Bit size | | multiple PSSCHs, assuming that N |
| | (single TB | | PSSCHs or TBs are jointly scheduled |
| 2^{nd}-stage SCI | repetition) | | by a single DCI) |
| HPN | 4 | bits | 4 × N bits |
| NDI | 1 | bit | N bits |
| RV | 2 | bits | 2 × N bits |
| Source ID | 8 | bits | 8 bits, common to all N PSSCHs or TBs |
| Destination ID | 16 | bits | 16 bits if all scheduled TBs are only |
| | | | targeted for the same destination; or |
| | | | 16 × N bits if all scheduled TBs can be |
| | | | targeted for different destinations. |
| HARQ | 1 | bit | 1 bit if all scheduled TBs can only have |
| enabling/ | | | the same HARQ enabling/disabling; or |
| disabling | | | N bits if all scheduled TBs can have |
| | | | different HARQ enabling/disabling. |
| Cast type | 2 | bits | 2 bits if all scheduled TBs can only |
| indicator | | | have the same cast type; or |
| | | | 2 × N bits if all scheduled TBs can have |
| | | | different cast types. |
| CSI request | 1 | bit | 1 bit, a single bit is enough to trigger a |
| | | | CSI request |
| Zone ID | 12 | bits | 12 bits, common to all scheduled TBs |
| Communication | 4 | bits | 4 bits common to all scheduled TBs if |
| range | | | all scheduled TBs are targeted for the |
| requirements | | | same service; or |
| | | | 4 × N bits separate to all scheduled TBs |
| | | | if all scheduled TBs can be targeted |
| | | | for different services. |

In some embodiments of the present disclosure, indicator #2 may be included in the 1^{st}-stage SCI. The payload size of the 1^{st}-stage SCI when the 1^{st}-stage SCI indicates a single TB is repeated on the plurality of scheduled PSSCHs is the same as that when multiple TBs are transmitted on the plurality of scheduled PSSCHs.

The payload size of the 2^{nd}-stage SCI may be kept the same regardless of the number of scheduled TBs or PSSCHs. For example, the payload size of the 2^{nd}-stage SCI may be determined based on the maximum number of TBs or PSSCHs schedulable by a single SCI. The maximum number of TBs (or PSSCHs) schedulable by a single SCI (e.g., M) may be configured by RRC signaling or predefined in, for example, a standard(s).

For example, it is assumed that a maximum of M TBs or PSSCHs can be jointly scheduled by a single SCI, then without consideration of 2^{nd}-stage SCI overhead reduction, the 2^{nd}-stage SCI may include, for example, 4×M bits for HARQ process number with (for example) every 4 consecutive bits corresponding to one TB (assuming that a maximum of 16 HARQ process numbers is supported), M bits for a NDI with each bit corresponding to one TB, 2×M bits for RVs with (for example) every 2 consecutive bits corresponding to one TB (assuming that a maximum of 4 RVs is supported), and other necessary fields, such as a field for a CSI request.

In some examples, considering the plurality of scheduled PSSCHs (or TBs) are transmitted from the same Tx UE, a source ID (e.g., 8 bits) may be included in the 2^{nd}-stage SCI and common to all the scheduled PSSCHs (or TBs). Similarly, a zone ID (e.g., 12 bits) may be included in the 2^{nd}-stage SCI and common for all the scheduled PSSCHs (or TBs).

In some examples, when all the scheduled TBs are targeted for the same destination, a destination ID (e.g., 16 bits) may be included in the 2^{nd}-stage SCI and common to all the scheduled TBs. Otherwise, 16×M bits may be needed in the 2^{nd}-stage SCI with (for example) every 16 consecutive bits corresponding to one destination ID for one of the maximum M scheduled TBs.

In some examples, when all the scheduled TBs can only have the same HARQ enabling/disabling option, a single HARQ enabling/disabling indicator (e.g., 1 bit) may be included in the 2^{nd}-stage SCI and common to all the scheduled TBs. Otherwise, M bits may be needed in the 2^{nd}-stage SCI with (for example) each bit corresponding to one of the maximum M scheduled TBs.

In some examples, when all the scheduled TBs can only have the same cast type, a single cast type indicator (e.g., 2 bits) may be included in the 2^{nd}-stage SCI and common to all the scheduled TBs. Otherwise, 2×M bits may be needed in the 2^{nd}-stage SCI with (for example) every two consecutive bits corresponding to one of the maximum M scheduled TBs.

In some examples, when all the scheduled TBs are only targeted for the same service, a single communication range requirements indicator (e.g., 4 bits) may be included in the 2^{nd}-stage SCI and common to all the scheduled TBs. Otherwise, 4×M bits may be needed in the 2^{nd}-stage SCI with (for example) every four consecutive bits corresponding to one of the maximum M scheduled TBs.

In some embodiments, the sizes of the fields related to HARQ enabling/disabling, destination ID, cast types and communication range requirements may be dependent on whether different HARQ enabling/disabling, destination IDs, cast types or services co-scheduled by a single SCI is allowed.

Table 2b below shows an exemplary format of 2^{nd}-stage SCI. It should be understood that Table 2b is only for illustrative purposes, and should not be construed as limiting the embodiments of the present disclosure.

TABLE 2b
Exemplary format of 2^{nd}-stage SCI

| | Bit size (assuming that max M TBs or PSSCHs |
|---|---|
| 2^{nd}-stage SCI | can be jointly scheduled by a single SCI) |
| HPN | 4 × M bits |
| NDI | M bits |
| RV | 2 × M bits |
| Source ID | 8 bits, common to all scheduled PSSCHs |
| Destination ID | 16 bits if all scheduled TBs are only targeted for the |
| | same destination; or |
| | 16 × M bits if all scheduled TBs can be targeted for |
| | different destinations. |
| HARQ | 1 bit if all scheduled TBs can only have the same |
| enabling/disabling | HARQ enabling/disabling; or |
| | M bits if all scheduled TBs can have different HARQ |
| | enabling/disabling. |
| Cast type | 2 bits if all scheduled TBs can only have the same cast |
| indicator | type; or |
| | 2 × M bits if all scheduled TBs can have different cast |
| | types. |
| CSI request | 1 bit, a single bit is enough to trigger a CSI request |
| Zone ID | 12 bits, common to all scheduled TBs |
| Communication | 4 bits common to all scheduled TBs if all scheduled |
| range | TBs are targeted for the same service; or |
| requirements | 4 × M bits separate to all scheduled TBs if all |
| | scheduled TBs can be targeted for different |
| | services. |

In some embodiments of the present disclosure, indicator #2 may be included in the 1^{st}-stage SCI. The payload size of the 1^{st}-stage SCI when the 1^{st}-stage SCI indicates a single TB is repeated on the plurality of scheduled PSSCHs is the same as that when multiple TBs are transmitted on the plurality of scheduled PSSCHs.

There are two payload sizes of the 2^{nd}-stage SCI: payload size #1A is the same as that of a single-PSSCH scheduling SCI and is applied when indicator #2 indicates that a single TB is repeated on the plurality of scheduled PSSCHs; and payload size #2A is determined based on the maximum number of TBs (or PSSCHs) schedulable by a single SCI (e.g., M) and is applied when indicator #2 indicates that each of the plurality of scheduled PSSCHs carries a different TB. The maximum number of TBs (or PSSCHs) schedulable by a single SCI (e.g., M) may be configured by RRC signaling or predefined in, for example, a standard(s).

For example, when indicator #2 indicates that a single TB is repeated on the plurality of scheduled PSSCHs (e.g., X=1), payload size #1A of the 2^{nd}-stage SCI is the same as that of a single-PSSCH scheduling SCI. For example, the payload size may be predefined in a standard(s). For example, the 2^{nd}-stage SCI may include a 4-bit HARQ process number, a 1-bit NDI, a 2-bit RV, an 8-bit source ID, a 16-bit destination ID, a 1-bit HARQ enabling/disabling, a 2-bit cast type indicator for the single TB, and other necessary fields, such as a field for a CSI request.

When indicator #2 indicates that each of the plurality of scheduled PSSCHs carries a different TB (e.g., X=N), payload size #2A of the 2^{nd}-stage SCI may be determined based on the maximum number of TBs or PSSCHs schedulable by a single SCI with TB-specific fields are assumed and included in the 2^{nd}-stage SCI.

For example, it is assumed that a maximum of M TBs or PSSCHs can be jointly scheduled by a single SCI, then without consideration of 2^{nd}-stage SCI overhead reduction, the 2^{nd}-stage SCI may include, for example, 4×M bits for HARQ process number with (for example) every 4 consecutive bits corresponding to one TB (assuming that a maximum of 16 HARQ process numbers is supported), M bits for a NDI with each bit corresponding to one TB, 2×M bits for RVs with (for example) every 2 consecutive bits corresponding to one TB (assuming that a maximum of 4 RVs is supported), and other necessary fields, such as a field for a CSI request.

In some examples, considering the plurality of scheduled PSSCHs (or TBs) are transmitted from the same Tx UE, a source ID (e.g., 8 bits) may be included in the 2^{nd}-stage SCI and common to all the scheduled PSSCHs (or TBs). Similarly, a zone ID (e.g., 12 bits) may be included in the 2^{nd}-stage SCI and common for all the scheduled PSSCHs (or TBs).

In some examples, when all the scheduled TBs are targeted for the same destination, a destination ID (e.g., 16 bits) may be included in the 2^{nd}-stage SCI and common to all the scheduled TBs. Otherwise, 16×M bits may be needed in the 2^{nd}-stage SCI with (for example) every 16 consecutive bits corresponding to one destination ID for one of the maximum M scheduled TBs.

In some examples, when all the scheduled TBs can only have the same HARQ enabling/disabling option, a single HARQ enabling/disabling indicator (e.g., 1 bit) may be included in the 2^{nd}-stage SCI and common to all the scheduled TBs. Otherwise, M bits may be needed in the 2^{nd}-stage SCI with (for example) each bit corresponding to one of the maximum M scheduled TBs.

In some examples, when all the scheduled TBs can only have the same cast type, a single cast type indicator (e.g., 2 bits) may be included in the 2^{nd}-stage SCI and common to all the scheduled TBs. Otherwise, 2×M bits may be needed in the 2^{nd}-stage SCI with (for example) every two consecutive bits corresponding to one of the maximum M scheduled TBs.

In some examples, when all the scheduled TBs are only targeted for the same service, a single communication range requirements indicator (e.g., 4 bits) may be included in the 2^{nd}-stage SCI and common to all the scheduled TBs. Otherwise, 4×M bits may be needed in the 2^{nd}-stage SCI with (for example) every four consecutive bits corresponding to one of the maximum M scheduled TBs.

In some embodiments, the sizes of the fields related to HARQ enabling/disabling, destination ID, cast types and communication range requirements may be dependent on whether different HARQ enabling/disabling, destination IDs, cast types or services co-scheduled by a single SCI is allowed.

Table 2c below shows an exemplary format of 2^{nd}-stage SCI. It should be understood that Table 2c is only for illustrative purposes, and should not be construed as limiting the embodiments of the present disclosure.

TABLE 2c
Exemplary format of 2^{nd}-stage SCI

| | | | Bit size (multiple different TBs on |
|---|---|---|---|
| | Bit size | | multiple PSSCHs, assuming that max M |
| | (single TB | | TBs or PSSCHs can be jointly scheduled |
| 2^{nd}-stage SCI | repetition) | | by a single SCI) |
| HPN | 4 | bits | 4 × M bits |
| NDI | 1 | bit | M bits |
| RV | 2 | bits | 2 × M bits |
| Source ID | 8 | bits | 8 bits, common to all scheduled PSSCHs |
| Destination ID | 16 | bits | 16 bits if all scheduled TBs are only |
| | | | targeted for the same destination; or |
| | | | 16 × M bits if all scheduled TBs can be |
| | | | targeted for different destinations. |
| HARQ | 1 | bit | 1 bit if all scheduled TBs can only have |
| enabling/disabling | | | the same HARQ enabling/disabling; or |
| | | | M bits if all scheduled TBs can have |
| | | | different HARQ enabling/disabling. |
| Cast type | 2 | bits | 2 bits if all scheduled TBs can only have |
| indicator | | | the same cast type; or |
| | | | 2 × M bits if all scheduled TBs can have |
| | | | different cast types. |
| CSI request | 1 | bit | 1 bit, a single bit is enough to trigger a |
| | | | CSI request |
| Zone ID | 12 | bits | 12 bits, common to all scheduled TBs |
| Communication | 4 | bits | 4 bits common to all scheduled TBs if |
| range | | | all scheduled TBs are targeted for the |
| requirements | | | same service; or |
| | | | 4 × M bits separate to all scheduled |
| | | | TBs if all scheduled TBs can be |
| | | | targeted for different services. |

In some embodiments of the present disclosure, indicator #2 may be included in the 2^{nd}-stage SCI. The payload size of the 1^{st}-stage SCI may be kept the same regardless of the value of indicator #2.

The payload size of the 2^{nd}-stage SCI may be kept the same regardless of the number of scheduled TBs or PSSCHs. For example, the payload size of the 2^{nd}-stage SCI may be determined based on the maximum number of TBs or PSSCHs schedulable by a single SCI. The maximum number of TBs (or PSSCHs) schedulable by a single SCI (e.g., M) may be configured by RRC signaling or predefined in, for example, a standard(s).

For example, it is assumed that a maximum of M TBs or PSSCHs can be jointly scheduled by a single SCI, then without consideration of 2^{nd}-stage SCI overhead reduction, the 2^{nd}-stage SCI may include, for example, 4×M bits for HARQ process number with (for example) every 4 consecutive bits corresponding to one TB (assuming that a maximum of 16 HARQ process numbers is supported), M bits for a NDI with each bit corresponding to one TB, 2×M bits for RVs with (for example) every 2 consecutive bits corresponding to one TB (assuming that a maximum of 4 RVs is supported), and other necessary fields, such as a field for a CSI request.

In some examples, considering the plurality of scheduled PSSCHs (or TBs) are transmitted from the same Tx UE, a source ID (e.g., 8 bits) may be included in the 2^{nd}-stage SCI and common to all the scheduled PSSCHs (or TBs). Similarly, a zone ID (e.g., 12 bits) may be included in the 2^{nd}-stage SCI and common for all the scheduled PSSCHs (or TBs).

In some examples, when all the scheduled TBs are targeted for the same destination, a destination ID (e.g., 16 bits) may be included in the 2^{nd}-stage SCI and common to all the scheduled TBs. Otherwise, 16×M bits may be needed in the 2^{nd}-stage SCI with (for example) every 16 consecutive bits corresponding to one destination ID for one of the maximum M scheduled TBs.

In some examples, when all the scheduled TBs can only have the same HARQ enabling/disabling option, a single HARQ enabling/disabling indicator (e.g., 1 bit) may be included in the 2^{nd}-stage SCI and common to all the scheduled TBs. Otherwise, M bits may be needed in the 2^{nd}-stage SCI with (for example) each bit corresponding to one of the maximum M scheduled TBs.

In some examples, when all the scheduled TBs can only have the same cast type, a single cast type indicator (e.g., 2 bits) may be included in the 2^{nd}-stage SCI and common to all the scheduled TBs. Otherwise, 2×M bits may be needed in the 2^{nd}-stage SCI with (for example) every two consecutive bits corresponding to one of the maximum M scheduled TBs.

In some examples, when all the scheduled TBs are only targeted for the same service, a single communication range requirements indicator (e.g., 4 bits) may be included in the 2^{nd}-stage SCI and common to all the scheduled TBs. Otherwise, 4×M bits may be needed in the 2^{nd}-stage SCI with (for example) every four consecutive bits corresponding to one of the maximum M scheduled TBs.

In some embodiments, the sizes of the fields related to HARQ enabling/disabling, destination ID, cast types and communication range requirements may be dependent on whether different HARQ enabling/disabling, destination IDs, cast types or services co-scheduled by a single SCI is allowed.

Table 2d below shows an exemplary format of 2^{nd}-stage SCI. The exemplary SCI format in Table 2d includes an indicator indicating whether a single TB or multiple different TBs are transmitted on the plurality of scheduled PSSCHs. It should be understood that Table 2d is only for illustrative purposes, and should not be construed as limiting the embodiments of the present disclosure.

TABLE 2d
Exemplary format of 2nd-stage SCI

| | Bit size (assuming that max M TBs or PSSCHs |
|---|---|
| 2^{nd}-stage SCI | can be jointly scheduled by a single SCI) |
| Indicator of TB | 1 bit, indicating whether a single TB or multiple |
| repetition | different TBs are transmitted on the plurality of |
| | scheduled PSSCHs |
| HPN | 4 × M bits |
| NDI | M bits |
| RV | 2 × M bits |
| Source ID | 8 bits, common to all scheduled PSSCHs |
| Destination ID | 16 bits if all scheduled TBs are only targeted for |
| | the same destination; or |
| | 16 × M bits if all scheduled TBs can be targeted for |
| | different destinations. |
| HARQ | 1 bit if all scheduled TBs can only have the same |
| enabling/disabling | HARQ enabling/disabling; or |
| | M bits if all scheduled TBs can have different |
| | HARQ enabling/disabling. |
| Cast type indicator | 2 bits if all scheduled TBs can only have the same |
| | cast type; or |
| | 2 × M bits if all scheduled TBs can have different |
| | cast types. |
| CSI request | 1 bit, a single bit is enough to trigger a CSI request |
| Zone ID | 12 bits, common to all scheduled TBs |
| Communication | 4 bits common to all scheduled TBs if all |
| range | scheduled TBs are targeted for the same service; or |
| requirements | 4 × M bits separate to all scheduled TBs if all |
| | scheduled TBs can be targeted for different |
| | services. |

From the perspective of a Tx UE, it can flexibly adjust its transmission policy. For example, the Tx UE can transmit a single TB repetition or multiple TBs on the plurality of co-scheduled PSSCHs for different purposes. The Tx UE may determine the payload size of the SCI (e.g., 1^{st}-stage SCI and 2^{nd}-stage SCI) according to one of the aforementioned embodiments and transmit the SCI (e.g., 1^{st}-stage SCI and 2^{nd}-stage SCI) to an Rx UE(s).

From the perspective of an Rx UE, it may monitor a SCI based on the SCI payload size determination methods as described above. In response to receiving a plurality of PSSCHs scheduled by a single SCI, the Rx UE may check indicator #2 to determine whether a single TB is repeated on the plurality of PSSCHs or each of the plurality of PSSCHs carries a different TB.

In the case that the Rx UE determines that a single TB is repeated on the plurality of scheduled PSSCHs, the Rx UE may generate a single ACK bit for the TB when at least one of the scheduled PSSCHs is correctly decoded, or a single NACK bit for the TB when none of the schedule PSSCHs is correctly decoded. The Rx UE may transmit the generated HARQ-ACK information bit according to, for example, the HARQ-ACK feedback option. For example, when ACK/NACK based feedback is employed, the Rx UE may transmit a single PSFCH indicating the generated ACK or NACK. When NACK-only based feedback is employed, the Rx UE may only transmit a single PSFCH indicating a NACK if NACK is generated for the TB.

In the case that the Rx UE determines that multiple TBs are jointly scheduled on the plurality of PSSCHs, the Rx UE may generate multiple HARQ-ACK information bits for the multiple transmitted TBs with (for example) each HARQ-ACK information bit corresponding to one of the multiple scheduled TBs. The Rx UE may transmit the generated HARQ-ACK information bits according to, for example, the HARQ-ACK feedback option. For example, when ACK/NACK based feedback is employed, the Rx UE may transmit multiple PSFCH indicating the generated ACK or NACK. When NACK-only based feedback is employed, the Rx UE may only transmit none, one, or more than one PSFCH indicating a NACK if a NACK is generated for a corresponding TB.

FIG. 4 illustrates a flow chart of exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a UE, for example, UE 110 in FIG. 1.

Referring to FIG. 4, in operation 411, a first UE may receive a plurality of PSSCHs scheduled by a first SCI, wherein the plurality of PSSCHs may carry at least one TB.

In operation 413, the first UE may determine, based on an indicator in the first SCI, a number of the at least one TB. The indicator may be indicator #1 or indicator #2 as described above.

In operation 415, the first UE may generate HARQ-ACK information bits for the plurality of PSSCHs, wherein a number of the HARQ-ACK information bits may be based on the number of the at least one TB. In operation 417, the first UE may transmit the HARQ-ACK information bits.

In some embodiments of the present disclosure, the indicator may indicate the number of the at least one TB being X.

In some embodiments of the present disclosure, each of the at least one TB may be mapped to an approximately equal number of PSSCHs of the plurality of PSSCHs. In some embodiments, each of a number of the at least one TB may be mapped to a first number of PSSCHs of the plurality of PSSCHs and each of the remaining TBs of the at least one TB may be mapped to a second number of PSSCHs of the plurality of PSSCHs. The difference between the first number and the second number may be equal to 0 or 1.

In some embodiments of the present disclosure, the first UE may receive a TB repetition number (e.g., K). The at least one TB may be mapped to the plurality of PSSCHs based on the TB repetition number. In some embodiments, each of a first number of TBs of the at least one TB may be transmitted on a number of PSSCHs equal to the TB repetition number among the plurality of PSSCHs, and each of the remaining TBs of the at least one TB may be transmitted on a number of PSSCHs smaller than the TB repetition number among the plurality of PSSCHs.

In some embodiments of the present disclosure, the at least one TB may be one-to-one mapped to the first X PSSCHs of the plurality of PSSCHs and then repeatedly one-to-one mapped to the remaining PSSCHs of the plurality of PSSCHs until there are no remaining PSSCHs in the plurality of PSSCHs.

In some embodiments of the present disclosure, the indicator may indicate whether a single TB is repeated on the plurality of PSSCHs or each of the plurality of PSSCHs carries a different TB. In some embodiments, the indicator may be specific for multi-PSSCH scheduling. In some embodiments, a SCI format indicator in the first SCI may be reused as the indicator.

In some embodiments of the present disclosure, a first TB of the at least one TB may be mapped to a first set of PSSCHs of the plurality of PSSCHs, the first SCI may indicate a first RV for a first scheduled PSSCH of the first set of PSSCHs, and an RV(s) for the remaining PSSCH(s) of the first set of PSSCHs follows the first RV based on an RV pattern. In some embodiments, the RV pattern may be configured by RRC signaling, or predefined, or preconfigured for the first UE. In some embodiments, the RV pattern may be indicated by the first SCI from a set of RV patterns, which may be configured by RRC signaling, or predefined, or preconfigured for the first UE.

In some embodiments of the present disclosure, a first TB of the at least one TB may be mapped to a first set of PSSCHs of the plurality of PSSCHs, the first SCI may indicate an RV pattern for the first set of PSSCHs, and an RV(s) for the PSSCH(s) of the first set of PSSCHs follows the RV pattern in order.

In some embodiments of the present disclosure, the first SCI further schedules a second SCI. In some embodiments, the second SCI may be multiplexed on a first scheduled PSSCH of the plurality of PSSCHs. In some embodiments, the second SCI may be multiplexed on each of the plurality of PSSCHs, or a set of PSSCHs of the plurality of PSSCHs.

In some embodiments of the present disclosure, the first SCI may include the indicator, and a payload size of the second SCI may be determined based on: the number of the at least one TB, a maximum number of TBs schedulable by the first SCI, or the indicator and the maximum number of TBs schedulable by the first SCI.

In some embodiments of the present disclosure, the second SCI may include the indicator, and a payload size of the second SCI may be determined based on the maximum number of TBs schedulable by the first SCI or the second SCI.

It should be appreciated by persons skilled in the art that the sequence of the operations in exemplary procedure 400 may be changed and some of the operations in exemplary procedure 400 may be eliminated or modified, without departing from the spirit and scope of the disclosure.

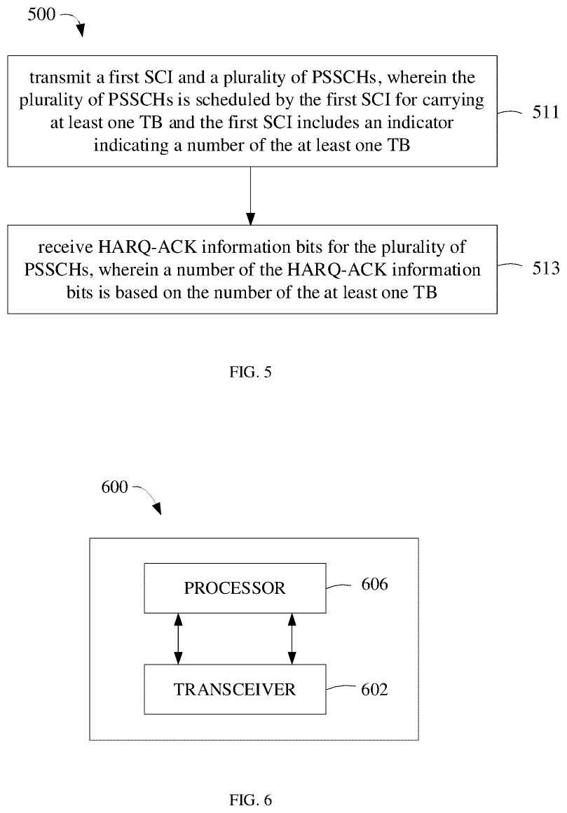

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE, for example, UE 110 in FIG. 1.

Referring to FIG. 5, in operation 511, a second UE may transmit a first SCI and a plurality of PSSCHs, wherein the plurality of PSSCHs is scheduled by the first SCI for carrying at least one TB and the first SCI includes an indicator indicating a number of the at least one TB. The indicator may be indicator #1 or indicator #2 as described above.

In operation 513, the second UE may receive HARQ-ACK information bits for the plurality of PSSCHs, wherein a number of the HARQ-ACK information bits is based on the number of the at least one TB.

In some embodiments of the present disclosure, the indicator may indicate the number of the at least one TB being X.

In some embodiments of the present disclosure, each of the at least one TB may be mapped to an approximately equal number of PSSCHs of the plurality of PSSCHs. In some embodiments, each of a number of the at least one TB may be mapped to a first number of PSSCHs of the plurality of PSSCHs and each of the remaining TBs of the at least one TB may be mapped to a second number of PSSCHs of the plurality of PSSCHs. The difference between the first number and the second number may be equal to 0 or 1.

In some embodiments of the present disclosure, the second UE may transmit a TB repetition number (e.g., K). The at least one TB may be mapped to the plurality of PSSCHs based on the TB repetition number. In some embodiments, each of a first number of TBs of the at least one TB may be transmitted on a number of PSSCHs equal to the TB repetition number among the plurality of PSSCHs, and each of the remaining TBs of the at least one TB may be transmitted on a number of PSSCHs smaller than the TB repetition number among the plurality of PSSCHs.

In some embodiments of the present disclosure, the at least one TB may be one-to-one mapped to the first X PSSCHs of the plurality of PSSCHs and then repeatedly one-to-one mapped to the remaining PSSCHs of the plurality of PSSCHs until there are no remaining PSSCHs in the plurality of PSSCHs.

In some embodiments of the present disclosure, the indicator may indicate whether a single TB is repeated on the plurality of PSSCHs or each of the plurality of PSSCHs carries a different TB. In some embodiments, the indicator may be specific for multi-PSSCH scheduling. In some embodiments, an SCI format indicator in the first SCI may be reused as the indicator.

In some embodiments of the present disclosure, a first TB of the at least one TB may be mapped to a first set of PSSCHs of the plurality of PSSCHs, the first SCI may indicate a first RV for a first scheduled PSSCH of the first set of PSSCHs, and an RV(s) for the remaining PSSCH(s) of the first set of PSSCHs follows the first RV based on an RV pattern. In some embodiments, the RV pattern may be configured by RRC signaling, or predefined, or preconfigured for the second UE. In some embodiments, the RV pattern may be indicated by the first SCI from a set of RV patterns, which may be configured by RRC signaling, or predefined, or preconfigured for the second UE.

In some embodiments of the present disclosure, a first TB of the at least one TB may be mapped to a first set of PSSCHs of the plurality of PSSCHs, the first SCI may indicate an RV pattern for the first set of PSSCHs, and an RV(s) for the PSSCH(s) of the first set of PSSCHs follows the RV pattern in order.

In some embodiments of the present disclosure, the first SCI may further schedule a second SCI. In some embodiments, the second SCI may be multiplexed on a first scheduled PSSCH of the plurality of PSSCHs. In some embodiments, the second SCI may be multiplexed on each of the plurality of PSSCHs, or a set of PSSCHs of the plurality of PSSCHs.

In some embodiments of the present disclosure, the first SCI may include the indicator, and a payload size of the second SCI may be determined based on: the number of the at least one TB, a maximum number of TBs schedulable by the first SCI, or the indicator and the maximum number of TBs schedulable by the first SCI.

In some embodiments of the present disclosure, the second SCI may include the indicator, and a payload size of the second SCI may be determined based on the maximum number of TBs schedulable by the first SCI or the second SCI.

It should be appreciated by persons skilled in the art that the sequence of the operations in exemplary procedure 500 may be changed and some of the operations in exemplary procedure 500 may be eliminated or modified, without departing from the spirit and scope of the disclosure.

FIG. 6 illustrates a block diagram of an exemplary apparatus 600 according to some embodiments of the present disclosure. As shown in FIG. 6, the apparatus 600 may include at least one processor 606 and at least one transceiver 602 coupled to the processor 606. The apparatus 600 may be a UE.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UE described in FIGS. 1-5.

In some embodiments of the present application, the apparatus 600 may further include at least one non-transitory computer-readable medium. For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602 to perform the operations with respect to the UE described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first user equipment (UE) for wireless communication, comprising:
at least one memory; and
at least one processor coupled with the at least one memory and configured to cause the UE to:
receive a plurality of physical sidelink shared channels (PSSCHs) scheduled by first sidelink control information (SCI), wherein the plurality of PSSCHs carry at least one transport block (TB);
determine, based on an indicator in the first SCI, a number of the at least one TB;
generate hybrid automatic repeat request acknowledgement (HARQ-ACK) information bits for the plurality of PSSCHs, wherein a number of the HARQ-ACK information bits is based on the number of the at least one TB; and
transmit the HARQ-ACK information bits.

2. (canceled)

3. The UE of claim 1, wherein each of the at least one TB is mapped to an approximately equal number of PSSCHs of the plurality of PSSCHs.

4. The UE of claim 3, wherein each of the number of the at least one TB is mapped to a first number of PSSCHs of the plurality of PSSCHs and each of the remaining TBs of the at least one TB is mapped to a second number of PSSCHs of the plurality of PSSCHs; and
wherein a difference between the first number and the second number is equal to 0 or 1.

5. The UE of claim 1, wherein the at least one processor is further configured to cause the UE to receive a TB repetition number, and the at least one TB is mapped to the plurality of PSSCHs based on the TB repetition number.

6. The UE of claim 5, wherein each of a first number of TBs of the at least one TB is transmitted on a number of PSSCHs equal to the TB repetition number among the plurality of PSSCHs, and each of the remaining TBs of the at least one TB is transmitted on a number of PSSCHs smaller than the TB repetition number among the plurality of PSSCHs.

7. The UE of claim 1, wherein the number of the at least one TB is an X-number, and the at least one TB is one-to-one mapped to a first X-number PSSCHs of the plurality of PSSCHs and then repeatedly one-to-one mapped to remaining PSSCHs of the plurality of PSSCHs until there are no remaining PSSCHs in the plurality of PSSCHs.

8. The UE of claim 1, wherein the indicator indicates whether a single TB is repeated on the plurality of PSSCHs or each of the plurality of PSSCHs carries a different TB.

9. The UE of claim 1, wherein a first TB of the at least one TB is mapped to a first set of PSSCHs of the plurality of PSSCHs, the first SCI indicates a first redundancy version (RV) for a first scheduled PSSCH of the first set of PSSCHs, and one or more RVs for remaining one or more PSSCHs of the first set of PSSCHs follows the first RV based on an RV pattern.

10. The UE of claim 9, wherein the RV pattern is one of:
configured by at least one of radio resource control (RRC) signaling, or predefined, or preconfigured for the first UE; or
indicated by the first SCI from a set of RV patterns, which is configured by at least one of the RRC signaling, or predefined, or preconfigured for the UE.

11. The UE of claim 1, wherein a first TB of the at least one TB is mapped to a first set of PSSCHs of the plurality of PSSCHs, the first SCI indicates a redundancy version (RV) pattern for the first set of PSSCHs, and one or more RVs for the one or more PSSCHs of the first set of PSSCHs follows the RV pattern in order.

12. The UE of claim 1, wherein the first SCI further schedules a second SCI, and the second SCI is multiplexed on at least one of a first scheduled PSSCH of the plurality of PSSCHs, each of the plurality of PSSCHs, or a set of PSSCHs of the plurality of PSSCHs.

13. The UE of claim 12, wherein:
the first SCI includes the indicator, and a payload size of the second SCI is determined based on at least one of the number of the at least one TB, a maximum number of TBs schedulable by the first SCI, or the indicator and the maximum number of TBs schedulable by the first SCI; or
the second SCI includes the indicator, and the payload size of the second SCI is determined based on the maximum number of TBs schedulable by the first SCI.

14. A user equipment (UE) for wireless communication, comprising:
at least one memory; and
at least one processor coupled with the at least one memory and configured to cause the UE to:
transmit first sidelink control information (SCI) and a plurality of physical sidelink shared channels (PSSCHs), wherein the plurality of PSSCHs is scheduled by the first SCI for carrying at least one transport block (TB) and the first SCI includes an indicator indicating a number of the at least one TB; and
receive hybrid automatic repeat request acknowledgement (HARQ-ACK) information bits for the plurality of PSSCHs, wherein a number of the HARQ-ACK information bits is based on the number of the at least one TB.

15. A method performed by a first user equipment (UE), the method comprising:
receiving a plurality of physical sidelink shared channels (PSSCHs) scheduled by first sidelink control information (SCI), wherein the plurality of PSSCHs carry at least one transport block (TB);
determining, based on an indicator in the first SCI, a number of the at least one TB;
generating hybrid automatic repeat request acknowledgement (HARQ-ACK) information bits for the plurality of PSSCHs, wherein a number of the HARQ-ACK information bits is based on the number of the at least one TB; and
transmitting the HARQ-ACK information bits.

16. A processor for wireless communication, comprising:
at least one controller coupled with at least one memory and configured to cause the processor to:
receive a plurality of physical sidelink shared channels (PSSCHs) scheduled by first sidelink control information (SCI), wherein the plurality of PSSCHs carry at least one transport block (TB);
determine, based on an indicator in the first SCI, a number of the at least one TB;
generate hybrid automatic repeat request acknowledgement (HARQ-ACK) information bits for the plurality of PSSCHs, wherein a number of the HARQ-ACK information bits is based on the number of the at least one TB; and
transmit the HARQ-ACK information bits.

17. The processor of claim 16, wherein each of the at least one TB is mapped to an approximately equal number of PSSCHs of the plurality of PSSCHs.

18. The processor of claim 17, wherein each of the number of the at least one TB is mapped to a first number of PSSCHs of the plurality of PSSCHs and each remaining TBs of the at least one TB is mapped to a second number of PSSCHs of the plurality of PSSCHs; and
wherein a difference between the first number and the second number is equal to 0 or 1.

19. The processor of claim 16, wherein the at least one controller is configured to cause the processor to receive a TB repetition number, and the at least one TB is mapped to the plurality of PSSCHs based on the TB repetition number.

20. The processor of claim 19, wherein each of a first number of TBs of the at least one TB is transmitted on a number of PSSCHs equal to the TB repetition number among the plurality of PSSCHs, and each remaining TBs of the at least one TB is transmitted on a number of PSSCHs smaller than the TB repetition number among the plurality of PSSCHs.

21. The processor of claim 16, wherein the number of the at least one TB is an X-number, and the at least one TB is one-to-one mapped to a first X-number PSSCHs of the plurality of PSSCHs and then repeatedly one-to-one mapped to remaining PSSCHs of the plurality of PSSCHs until there are no remaining PSSCHs in the plurality of PSSCHs.
